(19) United States
(12) Patent Application Publication
(10) Pub. No.: US 2021/0183253 A1
(43) Pub. Date: Jun. 17, 2021

(54) AIRCRAFT FLIGHT STRATEGY SELECTION SYSTEMS AND METHODS

(71) Applicant: THE BOEING COMPANY, Chicago, IL (US)

(72) Inventors: Marco LaCivita, Madrid (ES); Miguel Angel Vilaplana Ruiz, Madrid (ES)

(73) Assignee: THE BOEING COMPANY, CHICAGO, IL (US)

(21) Appl. No.: 17/121,824

(22) Filed: Dec. 15, 2020

(30) Foreign Application Priority Data
Dec. 16, 2019 (EP) 19383120.3

(51) Int. Cl. G08G 5/00; B64D 43/00; G05D 1/10

(52) U.S. Cl. CPC G08G 5/003; B64D 43/00; G05D 1/1062; G05D 1/106; G08G 5/0017

(57) ABSTRACT

An aircraft flight strategy selection system and method determine one or more possible flight strategies for an aircraft at an airport. The aircraft flight strategy selection system and method include a flight strategy analysis control unit that determines the possible flight strategies for the aircraft based on weather forecast data for a selected time period, flight schedule data for the selected time period, historical weather data for a prior time frame, and historical flight schedule data for the prior time frame.

### RELATED APPLICATIONS

This application claims priority to EP Application Number 19383120.3, filed Dec. 16, 2019, which is hereby incorporated by reference in its entirety.

### FIELD OF THE DISCLOSURE

Examples of the subject disclosure generally relate to aircraft flight strategy selection systems and methods, such as may be used to select flight strategies for landing at an airport.

### BACKGROUND OF THE DISCLOSURE

Various types of aircraft are used to transport passengers and cargo between various locations. For example, an aircraft departs from a departure airport and flies to an arrival airport.

Each aircraft flies from a departure airport to an arrival airport according to a particular flight plan. The flight plan may include a strategy for flying into the arrival airport. The flight plan includes a path to the arrival airport, altitudes for the aircraft at various positions along the path, air speed for the aircraft at various positions along the path, and the like. On any given day, a flight plan may differ due to changing variables, such as weather (including air temperature, precipitation, wind speed and direction, etc.), a number of scheduled flights to the airport, governmental regulations (such as noise restrictions, restricted airspace, etc.), and the like. Accordingly, one or more air traffic controllers typically determine flight plans for various aircraft each day after reviewing the variables for that day.

As can be appreciated, the process of determining particular flight strategies is time consuming and tedious. For example, an air traffic controller needs to account for numerous variables, such as the weather, scheduled flights, regulations, and the like to determine flight strategies for all of the flights that are scheduled to arrive at a particular airport on a particular day.

### SUMMARY OF THE DISCLOSURE

A need exists for a system and a method for efficiently identifying one or more flight strategies for aircraft that are scheduled to arrive at an airport. Further, a need exists for a system and a method for automatically selecting one or more flight strategies for aircraft that are scheduled to arrive at an airport.

With those needs in mind, certain examples of the subject disclosure provide an aircraft flight strategy selection system that is configured to determine one or more possible flight strategies for an aircraft at an airport. The aircraft flight strategy selection system includes a flight strategy analysis control unit that determines the possible flight strategy(s) for the aircraft based on weather forecast data for a selected time period, flight schedule data for the selected time period, historical weather data for a prior time frame, and historical flight schedule data for the prior time frame.

In at least one example, a historical flight strategy database is in communication with the flight strategy analysis control unit. The historical flight strategy database stores historical flight strategy data regarding various flight strategies to the airport during the prior time frame. The flight strategy analysis control unit analyzes the historical flight strategy data for a prior time period that is similar to the selected time period and identifies one or more flight strategies for the prior time period as the possible flight strategy(s) for the selected time period. In at least one example, the flight strategy analysis control unit includes a strategies selection module that analyzes the historical flight strategy data and identifies the possible flight strategy(s) for the selected time period.

In at least one example, a historical weather database is in communication with the flight strategy analysis control unit. The historical weather database stores the historical weather data. The flight strategy analysis control unit compares the weather forecast data for the selected time period with the historical weather data. The flight strategy analysis control unit determines one or more time periods from the historical weather data having weather conditions that are at least substantially similar as weather conditions for the selected time period as determined via the weather forecast data. In at least one example, the flight strategy analysis control unit includes a conditions comparison module that analyzes the historical weather data and the weather forecast data.

In at least one example, a weather forecasting sub-system is in communication with the flight strategy analysis control unit. The flight strategy analysis control unit receives the weather forecast data from the weather forecasting sub-system.

In at least one example, a historical flight schedule database is in communication with the flight strategy analysis control unit. The historical flight schedule database stores the historical flight schedule data. The flight strategy analysis control unit compares the flight schedule data with the historical flight schedule data. The flight strategy analysis control unit determines one or more days or time periods from the historical flight schedule data having a prior flight schedule that is at least substantially similar as a future flight schedule as determined via the flight schedule data for the selected time period. In at least one example, the flight strategy analysis control unit includes a conditions comparison module that analyzes the historical flight schedule data and the flight schedule data.

In at least one example, a flight schedule sub-system is in communication with the flight strategy analysis control unit. The flight strategy analysis control unit receives the flight schedule data from the flight schedule sub-system.

In at least one example, an aircraft database is in communication with the flight strategy analysis control unit. The aircraft database stores aircraft data regarding the aircraft. The flight strategy analysis control unit analyzes the aircraft data to determine capabilities of the aircraft and aircraft capable flight strategies for the aircraft. In at least one example, the flight strategy analysis control unit includes an aircraft capabilities module that analyzes the aircraft data.

In at least one example, the flight strategy analysis control unit compares the possible flight strategy(s) for the selected time period in relation to one or more metrics including one or more of flight time, fuel consumption, or generated noise. In at least one example, the flight strategy analysis control unit includes a strategies comparison module that associates the metric(s) with the possible flight strategy(s) for the selected time period.

Certain examples of the subject disclosure provide an aircraft flight strategy determination method that is configured to determine one or more possible flight strategies for an aircraft at an airport. The aircraft flight strategy determination method includes determining, by a flight strategy analysis control unit, the possible flight strategies for the aircraft based on weather forecast data for a selected time period, flight schedule data for the selected time period, historical weather data for a prior time frame, and historical flight schedule data for the prior time frame.

In at least one example, the aircraft flight strategy determination method includes storing, in a historical flight strategy database that is in communication with the flight strategy analysis control unit, historical flight strategy data regarding various flight strategies to the airport during the prior time frame, analyzing, by the flight strategy analysis control unit, the historical flight strategy data for a prior time period that is similar to the selected time period, and identifying, by the flight strategy analysis control unit, one or more flight strategies for the prior time period as the possible flight strategy(s) for the selected time period.

In at least one example, the aircraft flight strategy determination method includes storing, in a historical weather database that is in communication with the flight strategy analysis control unit, the historical weather data, comparing, by the flight strategy analysis control unit, the weather forecast data for the selected time period with the historical weather data, and determining, by the flight strategy analysis control unit, one or more time periods from the historical weather data having weather conditions that are at least substantially similar as weather conditions for the selected time period as determined via the weather forecast data. In at least one example, the method also includes receiving the weather forecast data from a weather forecasting sub-system that is in communication with the flight strategy analysis control unit.

In at least one example, the aircraft flight strategy determination method includes storing, in a historical flight schedule database that is in communication with the flight strategy analysis control unit, the historical flight schedule data, comparing, by the flight strategy analysis control unit, the flight schedule data with the historical flight schedule data, and determining, by the flight strategy analysis control unit, one or more days or time periods from the historical flight schedule data having a prior flight schedule that is at least substantially similar as a future flight schedule as determined via the flight schedule data for the selected time period. In at least one example, the method also includes receiving, from a flight schedule sub-system that is in communication with the flight strategy analysis control unit, the flight schedule data.

In at least one example, the aircraft flight strategy determination method includes storing, in an aircraft database that is in communication with the flight strategy analysis control unit, aircraft data regarding the aircraft, and analyzing, by the flight strategy analysis control unit, the aircraft data to determine capabilities of the aircraft and aircraft capable flight strategies for the aircraft.

In at least one example, the aircraft flight strategy determination method includes comparing, by the flight strategy analysis control unit, the possible flight strategy(s) for the selected time period in relation to one or more metrics including one or more of flight time, fuel consumption, or generated noise.

### BRIEF DESCRIPTION OF THE DRAWINGS

FIG. 1 illustrates a simplified representation of flight strategies for an aircraft to an airport.

FIG. 2 is a schematic block diagram of a flight strategy selection system, according to an example of the subject disclosure.

FIG. 3 illustrates a flow chart of a flight strategy selection method, according to an example of the subject disclosure.

FIG. 4 is a diagrammatic representation of a front perspective view of the aircraft, according to an example of the subject disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising,” “including,” “containing,” or “having” an element or a plurality of elements having a particular condition may include additional elements not having that condition.

Certain examples of the subject disclosure provide an aircraft flight strategy selection system and method that is configured to identify a group or cluster of flight strategies to an airport, and select one or more of the flight strategies based on particular conditions. In at least one example, the aircraft flight strategy selection system and method includes a flight strategy analysis control unit. In at least one example, the flight strategy analysis control unit includes one or more modules that generate (for example, retrieve) multiple possible flight strategies, groups the flight strategies into one or more clusters based on particular aircraft positions, selects one or more of the flight strategies based on one or more conditions based on particular metrics, and communicates with an individual (such as a pilot, air traffic controller, or the like) to allow the selected flight strategies to be changed.

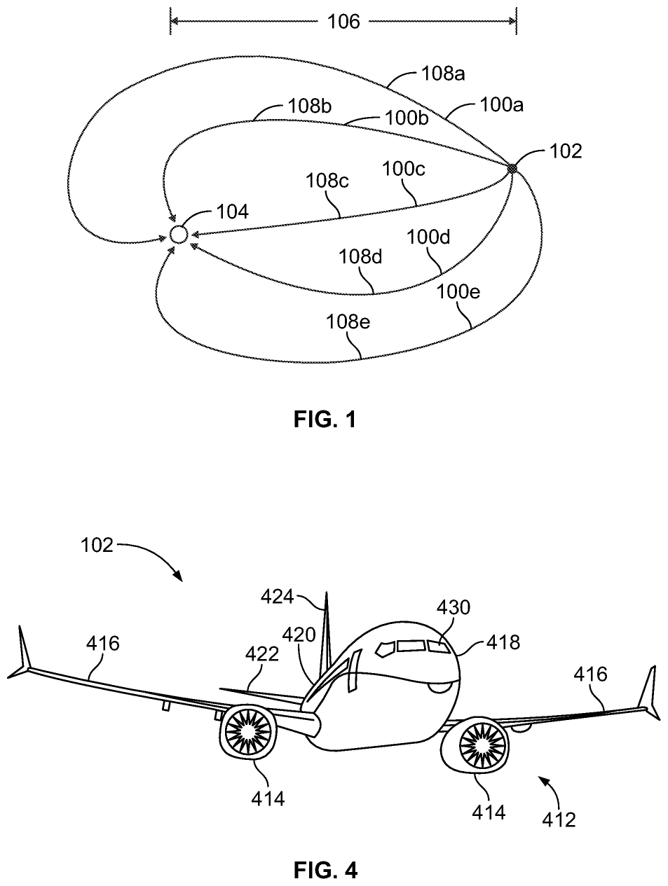

FIG. 1 illustrates a simplified representation of flight strategies 100a, 100b, 100c, 100d, and 100e for an aircraft 102 to an airport 104. The flight strategies 100a, 100b, 100c, 100d, and 100e are a particular predetermined range 106 between the aircraft 102 and the airport 104. In at least one example, the range 106 is from a departure airport to the airport 104 (that is, the arrival airport 104). In at least one other example, the range 106 is less than a distance between the departure airport and the airport 104. For example, the range 106 is 100 miles. As another example, the range is 200 miles. As another example, the range is 50 miles. The range 106 may be greater than 200 miles, or less than 50 miles.

In at least one example, the flight strategies 100a, 100b, 100c, 100d, and 100e are previously flown paths to the airport 104 from a location within the range 106, such as the point represented by the aircraft 102. That is, the flight strategies 100a, 100b, 100c, 100d, and 100e are each historical flight paths including trajectories, airspeeds, altitudes, and the like at each point thereon. In at least one example, the flight strategies 100a, 100b, 100c, 100d, and 100e are not new or newly-formed flight strategies.

FIG. 1 shows a set of flight strategies 100a, 100b, 100c, 100d, and 100e that have already been used to fly aircraft to the airport 104. A particular one of the flight strategies 100a, 100b, 100c, 100d, or 100e is selected for a current or future flight, as described herein. The set of flight strategies 100a, 100b, 100c, 100d, and 100e may include more or less flight strategies than shown.

Each flight strategy 100a, 100b, 100c, 100d, and 100e includes a flight route 108a, 108b, 108c, 108d, and 108e, respectively, to the airport 104, which include trajectories at various positions along each of the flight routes 108a, 108b, 108c, 108d, 108e, altitudes at various positions along each of the flight routes 108a, 108b, 108c, 108d, and 108e, and airspeeds at the various positions along each of the flight routes 108a, 108b, 108c, 108d, and 108e. The trajectories, airspeeds, and altitudes at different positions along each of the flight routes 108a, 108b, 108c, 108d, and 108e may differ. For example, the trajectory, airspeed, and altitude of the aircraft 102 at a position 100 miles from the airport 104 differs from the trajectory, airspeed and altitude of the aircraft 102 at a position immediately before landing at the airport 104.

The flight strategies 100a, 100b, 100c, 100d, and 100e differ based on various past conditions. For example, the flight strategies 100a, 100b, 100c, 100d, and 100e differ due to past weather conditions (including wind speed and direction, the presence of precipitation, air temperature, humidity, and/or the like), a flight schedule for a particular day (including the number of flights scheduled to land at the airport), and governmental regulations (for example, noise restrictions in relation to locations proximate to the airport 104, restricted airspace proximate to the airport 104, and/or the like).

The flight strategy 100c provides a relatively direct route to the airport 104. As such, the aircraft 102 that flies according to the flight strategy 100c generally consumes the least amount of fuel. However, the flight strategy 100c may not be an option on a particular day due to weather conditions (such as the presence of a storm in the flight route 108c).

The flight strategies 100a, 100b, 100d, and 100e provide longer flight routes 108a, 108b, 108d, and 108e than the flight route 108c of the flight strategy 100c, but are selected based on conditions that advise against the flight strategy 100c. For example, weather conditions may cause selection of a flight strategy 100a, 100b, 100d, or 100e to avoid storms, or based on a wind speed and direction at the airport 104.

While five different flight strategies 100a, 100b, 100c, 100d, and 100e are shown, more or less flight strategies than shown may be used over a particular time period. For example, on a particular day, a single flight strategy may be used. As another example, on a particular day, three flight strategies may be used. As another example, on a particular day, ten flight strategies may be used. As another example, over the course of a month, season, or year, hundreds, if not thousands of flight strategies may be used.

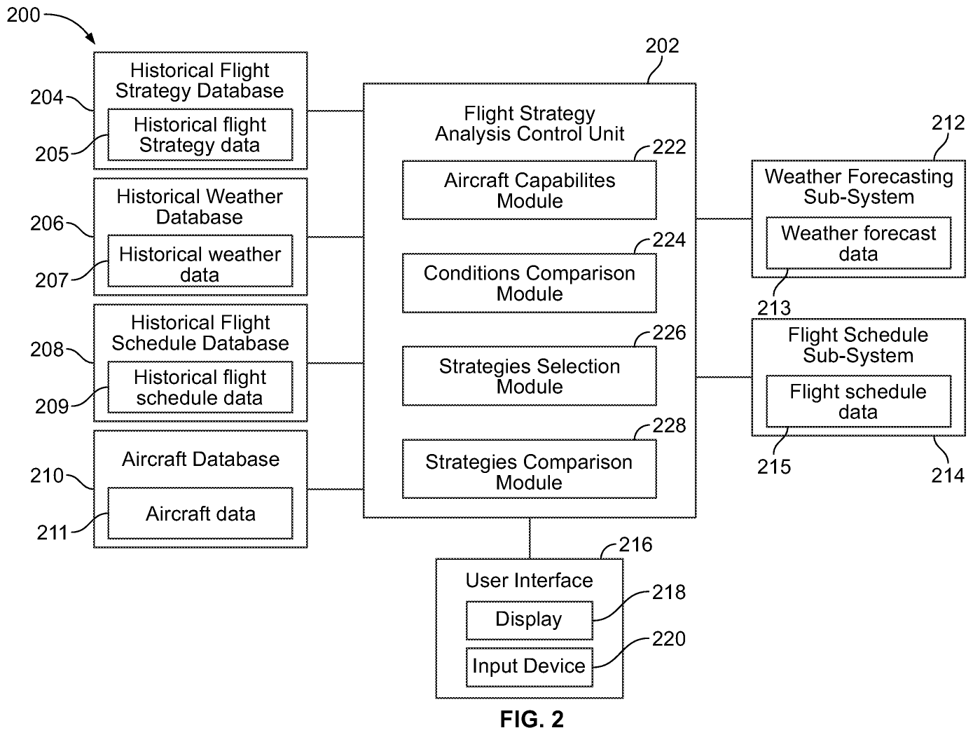

FIG. 2 is a schematic block diagram of an aircraft flight strategy selection system 200, according to an example of the subject disclosure. The aircraft flight strategy selection system 200 includes a flight strategy analysis control unit 202 in communication with a historical flight strategy database 204, a historical weather database 206, a historical flight schedule database 208, and an aircraft database 210, such as through one or more wired or wireless connections. In at least one example, the flight strategy analysis control unit 202 is collocated with the historical flight strategy database 204, the historical weather database 206, the historical flight schedule database 208, and the aircraft database 210. In at least one other example, the flight strategy analysis control unit 202 is remotely located from one or more of the historical flight strategy database 204, the historical weather database 206, the historical flight schedule database 208, and/or the aircraft database 210. In at least one example, the flight strategy analysis control unit 202 is in communication with less than all of the historical flight strategy database 204, the historical weather database 206, the historical flight schedule database 208, and the aircraft database 210.

The historical flight strategy database 204 stores historical flight strategy data 205. The historical flight strategy data 205 is or otherwise includes information regarding various flight strategies that have previously been used to route aircraft to the airport 104 (shown in FIG. 1) during a prior time frame. The prior time frame may be a prior day, a week, a month, a year, or longer for a current day and time. As an example, the historical flight strategy database 204 stores historical flight strategy data 205 that dates back at least one year from a current time. The historical flight strategy data 205 may include tens, hundreds, thousands, or more flight strategies (such as the flight strategies 100a, 100b, 100c, 100d, and 100e) to the airport 104 over the prior time frame. The prior time frame or period may be selected by an individual via the user interface 216.

The historical weather database 206 stores historical weather data 207. The historical weather data 207 is or otherwise includes information regarding previous weather conditions (such as air temperature, humidity, precipitation, wind speed, wind direction, and the like) at or proximate (such as within the range 106 shown in FIG. 1) the airport 104 during the prior time frame. As an example, the historical weather database 206 stores the historical weather data 207 that dates back at least one year from the current time.

The historical flight schedule database 208 stores historical flight schedule data 209 to the airport 104. The historical flight schedule data 209 is or otherwise includes information regarding the previous flight schedules to the airport 104 for each day within the prior time frame. As an example, the historical flight schedule database 208 stores the historical flight schedule data 209 that dates back at least one year from the current time.

The aircraft database 206 stores aircraft data 211. The aircraft data 211 is or otherwise includes information regarding the aircraft 102. For example, the aircraft data 211 includes aircraft type, maximum airspeed, maximum altitude, maximum weight, seating capacity, and the like for the aircraft 102.

In at least one example, the historical flight strategy database 204, the historical weather database 206, the historical flight schedule database 208, and the aircraft database 210 are separate and distinct databases. In at least one other example, the historical flight strategy database 204, the historical weather database 206, the historical flight schedule database 208, and the aircraft database 210 are part of an integrated database, with each of the databases 204, 206, 208, and 210 being portions of the integrated database.

The aircraft flight strategy analysis control unit 202 is also in communication with a weather forecasting sub-system 212 and a flight schedule sub-system 214, such as through one or more wired or wireless connections. In at least one example, the flight strategy analysis control unit 202 is remotely located from the weather forecasting sub-system 212 and the flight schedule sub-system 214. In at least one other example, the flight strategy analysis control unit 202 is collocated with one or both of the weather forecasting sub-system 212 or the flight schedule sub-system 214.

In at least one example, the weather forecasting sub-system 212 is a weather forecasting service that generates weather forecast data 213 for the current day or any time period for which flight strategies are to be determined. The weather forecast data 213 includes information regarding air temperature, humidity, precipitation, wind speed, wind direction, and the like at or proximate the airport 104 on a current or future day (in contrast to previous days, for which historical weather data 207 is stored in the historical weather database 206).

In at least one example, the flight schedule sub-system 214 is an aircraft schedule generation system for the airport 104. The flight schedule sub-system 214 generates flight schedule data 215 that includes information regarding scheduled flights that are to arrive at and depart from the airport 104 during a selected or otherwise relevant time period, such as a current day or future days.

The flight strategy analysis control unit 202 is also in communication with a user interface 216 through one or more wired or wireless connections. In at least one example, the user interface 216 is collocated with the flight strategy analysis control unit 202, such as a central monitoring location, which may be at the airport 104. In at least one other example, the user interface 216 is remotely located from the flight strategy analysis control unit 202. For example, the user interface 216 may be onboard the aircraft 102.

The user interface 216 includes a display 218 in communication with an input device 220, such as through one or more wired or wireless connections. The display 218 may be or otherwise include a monitor, screen, television, or the like. The input device 220 may be or otherwise include a keyboard, mouse, or the like. In at least one example, the display 218 and the input device 220 are integrated into a touchscreen interface. In at least one example, the user interface 216 is part of a computer workstation. In at least one other example, the user interface 216 is part of a handheld device, such as a smart phone, table, or other such device.

Referring to FIGS. 1 and 2, in operation, the flight strategy analysis control unit 202 determines one or more flight strategies for the aircraft 102 to arrive at the airport 104. For example, in at least one example, the flight strategy analysis control unit 202 identifies one or more previously-flow strategies that aircraft have flown to the airport 104. In at least one example, the flight strategy analysis control unit 202 does not generate a new flight strategy, but instead identifies previously-flown flight strategies.

Initially, a time period for selecting a flight strategy for an aircraft to an airport is selected. The time period may be a current day. In at least one other example, the time period may be less than an entire twenty four hours of a current or future day. In at least one other example, the time period may be longer than a current day, such as multiple days, a week, or longer. The relevant time period may be selected by an individual, such as via the user interface 216.

In at least one example, the flight strategy analysis control unit 202 receives the aircraft data 211 regarding the aircraft 102 from the aircraft database 210. The flight strategy analysis control unit 202 analyzes the aircraft data 211 to determine capabilities of the aircraft 102 and further capable flight strategies for the aircraft 102. The flight strategy analysis control unit 202 analyzes the aircraft data 211 to determine whether the aircraft 102 can fly according to a particular flight strategy, such as may have been previously flown to the airport 104 by another aircraft. The flight strategy analysis control unit 202 saves (such as in a memory) possible flight strategies (such as previously-flown flight strategies) that the aircraft 102 is capable of flying (that is, aircraft capable flight strategies, such as those having airspeeds and altitudes that are less than a maximum airspeed and a maximum altitude, respectively of the aircraft 102), and discards flight strategies that the aircraft 102 is incapable of flying (such as those having air speeds and altitudes that exceed a maximum airspeed and a maximum altitude, respectively, of the aircraft 102). For example, the flight strategy analysis control unit 202 may include an aircraft capabilities module 222, which may be a processing portion of the flight strategy analysis control unit 202. The aircraft capabilities module 222 analyzes the aircraft data 211 to determine the aircraft capable flight strategies.

The flight strategy analysis control unit 202 receives the weather forecast data 213 from the weather forecasting sub-system 212 and the flight schedule data 215 from the flight schedule sub-system 214. The flight strategy analysis control unit 202 compares the weather forecast data 213 and the flight schedule data 215 with the historical weather data 207 from the historical weather database 206 and the historical flight schedule data 209 from the historical flight schedule database 208 over a particular time frame, such as may be chosen by an individual via the user interface 216. The flight strategy analysis control unit 202 determines one or more days from the historical weather data 207 and the historical flight schedule data 209 having weather conditions and a flight schedule that are the same as, or substantially the same as (such as within a predetermined percentage of similarity, such as 90% or more the same, 80% or more the same, or the like) the weather conditions (as determined via the weather forecast data 213) and the flight schedule (as determined via the flight schedule data 215) of the current day. For example, current weather conditions are substantially similar with historical weather data 207 if the amount of precipitation, wind speed and direction, temperature, and the like are within a predetermined similarity percentage. Similarly between current conditions, times, flight schedules, and the like and respective stored data may be similarly determined. In at least one example, the flight strategy analysis control unit 202 may not analyze the flight schedule data 215 to determine similar conditions for the current day. For example, the flight strategy analysis control unit 202 may include a conditions comparison module 224, which may be a processing portion of the flight strategy analysis control unit 202. The conditions comparison module 224 analyzes current conditions for the current day (through the weather forecast data 213 and the flight schedule data 215) to determine conditions for similar days (in relation to a selected time period), such as through a comparison the current conditions data with the historical weather data 207 and the historical flight schedule data 209 and identifies a day having a close similarity to the current day (that is, a similar day).

After identifying the similar day, the flight strategy analysis control unit 202 analyzes the historical flight strategy data 205 for the similar day. The historical fight plan data 205 for the similar day includes one or more flight strategies for the aircraft 102 to the airport 104. For example, the historical flight strategy data 205 includes the flight strategies 100a, 100b, 100c, 100d, and 100e for the similar day. The flight strategy analysis control unit 202 identifies the flight strategies for the similar day as possible flight strategies for the current day. The possible flight strategies are in agreement with the aircraft capable flight strategies, such as determined by the aircraft capabilities module 222. That is, if the aircraft 102 is incapable of flying according to a particular flight strategy for the similar day, the flight strategy analysis control unit 202 discards such flight strategy for the aircraft 102. As an example, the flight strategy analysis control unit 202 may include a strategies selection module 226, which may be a processing portion of the flight strategy analysis control unit 202. The strategies selection module 226 identifies the flight strategies for the similar day as possible flight strategies for the current day.

After the possible flight strategies are determined, the flight strategy analysis control unit 202 compares the possible flight strategies for the current day in relation to one or more metrics. The metrics include one or more of flight time, fuel consumption, generated noise, and the like. For example, the flight strategy analysis control unit 202 determines that the aircraft 102 flying according to the flight strategy 100c arrives at the airport 104 the quickest (for example, the flight strategy 100c is the quickest flight strategy), the aircraft 102 flying according to the flight strategy 100a generates the least amount of noise in relation to the airport 104 or one or more locations proximate to the airport 104 (for example, the flight strategy 100a is the quietest flight strategy), while the aircraft 102 flying according to the flight strategy 100d consumes the least amount of fuel (for example, the flight strategy 100d is the most fuel efficient flight strategy). In at least one example, the flight strategy analysis control unit 202 presents the different possible flight strategies and associated metrics (for example, flight time, fuel consumption, and generated noise) to an individual on the display 218 of the user interface 216. As an example, the flight strategy analysis control unit 202 may include a strategies comparison module 228, which may be a processing portion of the flight strategy analysis control unit 202. The strategies comparison module 228 associates metrics with the possible flight strategies for the current day.

A user (such as an air traffic controller or a pilot) at the user interface 216 may select a desired possible flight strategy for the aircraft 102, such as via the input device 220. For example, the user may select one of the possible flight strategies based on a particular metric.

As shown, in at least one example, the flight strategy analysis control unit 202 includes the aircraft capabilities module 222, the conditions comparison module 224, the strategies selection module 226, and the strategies comparison module 228. The modules 222, 224, 226, and 228 may be processing portions of the flight strategy analysis control unit 202. In at least one module, the modules 222, 224, 226, and 228 may be integrated into a single processing unit. In at least one example, the flight strategy analysis control unit 202 may not include separate and distinct modules. Instead, the flight strategy analysis control unit 202 may perform the operations as described herein in an integrated manner.

As described herein, the current day is a time period analyzed by the flight strategy analysis control unit 202 that may be an entire 24 hour time period measured from 12 AM until 12 PM. Optionally, the time period may be less than entire 24 hour period of a day. For example, the time period may be an operational period for an aircraft for a particular day. As another example the time period may be selected, such as by an individual via the user interface 216, as a particular time period (such as a 2 hour time period) within a longer time period. In at least one example, the flight strategy analysis control unit 202 determines (for example, identifies) possible flight strategies for a time period (such as a current and/or future time period) that lasts one or more hours, a day, multiple days, a week, or multiple weeks based on forecasted weather data 213 and/or flight schedule data 215 for the relevant time period through an analysis of the historical flight strategy data 205, the historical weather data 207 and the historical flight schedule data 209.

As used herein, the term “control unit,” “central processing unit,” “unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the flight strategy analysis control unit 202 (and/or portions thereof) may be or include one or more processors that are configured to control operation thereof, as described herein.

The flight strategy analysis control unit 202 is configured to execute a set of instructions that are stored in one or more data storage units or elements (such as one or more memories), in order to process data. For example, the flight strategy analysis control unit 202 may include or be coupled to one or more memories. The data storage units may also store data or other information as desired or needed. The data storage units may be in the form of an information source or a physical memory element within a processing machine.

The set of instructions may include various commands that instruct the flight strategy analysis control unit 202 as a processing machine to perform specific operations such as the methods and processes of the various examples of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of examples herein may illustrate one or more control or processing units, such as the flight strategy analysis control unit 202. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the flight strategy analysis control unit 202 may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

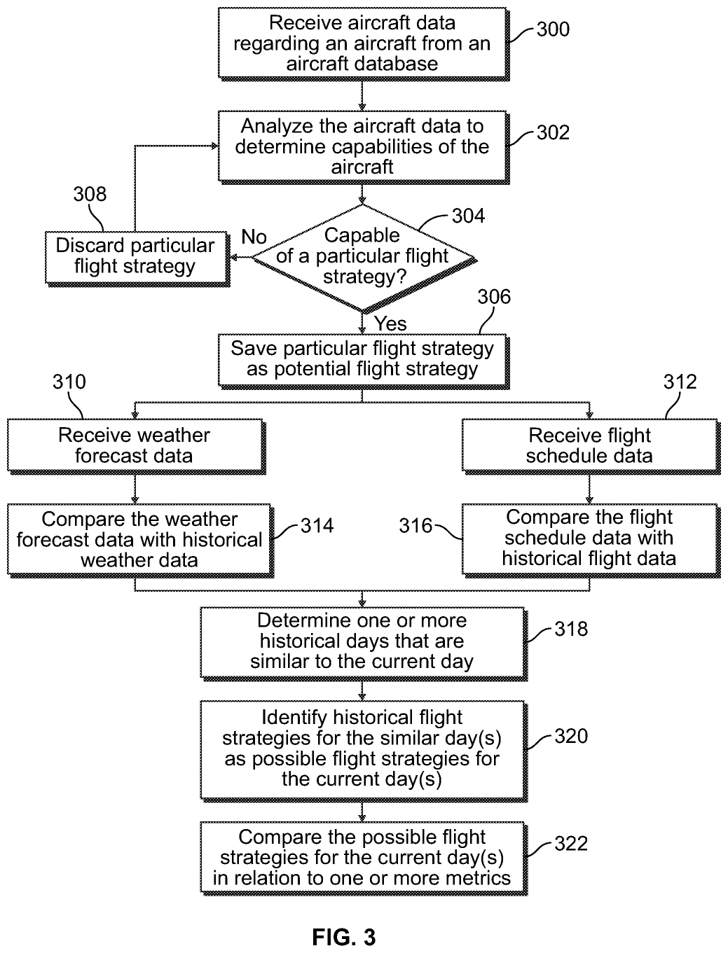

FIG. 3 illustrates a flow chart of an aircraft flight strategy selection method, according to an example of the subject disclosure. In at least one example, the flight strategy analysis control unit 202 operates according to the flow chart shown and described with respect to FIG. 3.

Referring to FIGS. 1-3, at 300, the flight strategy analysis control unit 202 receives the aircraft data 211 regarding the aircraft 102 from the aircraft database 210. At 302, the flight strategy analysis control unit 202 analyzes the aircraft data 211 to determine capabilities of the aircraft 102. At 304, the flight strategy analysis control unit 202 determines, based on the aircraft data 211, whether the aircraft 102 is capable of flying according to a particular flight strategy. If the aircraft is capable of flying according to the particular flight strategy, such flight strategy is saved as a potential flight strategy at 306. If, however, the aircraft is incapable of flying according to the particular flight strategy, the particular flight strategy is discarded at 308, and the method returns to 302.

At 310, the flight strategy analysis control unit 202 receives the weather forecast data 213. At 312, the flight strategy analysis control unit 202 receives the flight schedule data 215 from the flight schedule sub-system 214. In at least one example, the method does not include 300-308, but begins at 310 and 312. In at least one other example, the method does not include 312.

At 314, the flight strategy analysis control unit 202 compares the weather forecast data 213 with the historical weather data 207 in relation to a particular time frame, such as may be chosen by an individual via the user interface 216. At 316, the flight strategy analysis control unit compares the flight schedule data with historical flight schedule data 209 in relation to a particular time frame, such as may be chosen by an individual via the user interface 216. In at least one example, the method may not include 316.

At 318, the flight strategy analysis control unit 202 determines one or more days from the historical weather data 207 and the historical flight schedule data 209 that are similar to the current day. For example, the flight strategy analysis control unit 202 determines one or more historical days having weather conditions and a flight schedule that are the same as, or substantially the same as (such as within a predetermined percentage of similarity, such as 90% or more similar) the weather conditions (as determined via the weather forecast data 213) and the flight schedule (as determined via the flight schedule data 215) of the current day.

At 320, after identifying the similar day, the flight strategy analysis control unit 202 identifies the flight strategies for the similar day(s) as possible flight strategies for the current day(s). After the possible flight strategies are determined (for example, identified), at 322, the flight strategy analysis control unit 202 compares the possible flight strategies for the current day in relation to one or more metrics.

FIG. 4 is a diagrammatic representation of a front perspective view of the aircraft 102, according to an example of the subject disclosure. The aircraft 102 includes a propulsion system 412 that may include two turbofan engines 414, for example. Optionally, the propulsion system 412 may include more engines 414 than shown. The engines 414 are carried by wings 416 of the aircraft 102. In other examples, the engines 414 may be carried by a fuselage 418 and/or an empennage 420. The empennage 420 may also support horizontal stabilizers 422 and a vertical stabilizer 424. The fuselage 418 of the aircraft 102 defines an internal cabin, which may include a cockpit 430.

The aircraft 102 may be sized, shaped, and configured other than shown in FIG. 4. For example, the aircraft 102 may be a non-fixed wing aircraft, such as a helicopter.

Examples of the subject disclosure provide systems and methods that allow large amounts of data to be quickly and efficiently analyzed by a computing device. Large amounts of data are being tracked and analyzed. The vast amounts of data are efficiently organized and/or analyzed by the flight strategy analysis control unit 202, as described herein. The flight strategy analysis control unit 202 analyzes the data in a relatively short time in order to quickly and efficiently select one or more possible flight strategies. A human being would be incapable of efficiently analyzing such vast amounts of data in such a short time. As such, examples of the subject disclosure provide increased and efficient functionality with respect to prior computing systems, and vastly superior performance in relation to a human being analyzing the vast amounts of data. In short, examples of the subject disclosure provide systems and methods that analyze thousands, if not millions, of calculations and computations that a human being is incapable of efficiently, effectively and accurately managing.

Examples of the subject disclosure provide systems and methods that provide decision-support tools that allow airlines, air traffic controllers, and the like to efficiently analyze flight operations, and identify specific flight procedures that provide effective flight strategies for arrival at an airport. In at least one example, the systems and methods identify a plurality of flight strategies, each of which may differ with respect to metrics including flight time, fuel consumption, noise restrictions, and the like. As such, in at least one example, a particular flight strategy is chosen based on emphasis of a particular metric (for example, the shortest flight time, the least amount of fuel consumption, or the lowest amount of noise generated in relation to a particular location).

As described herein, examples of the subject disclosure provide systems and methods for efficiently selecting one or more flight strategies for aircraft that are scheduled to arrive at an airport. Further, examples of the subject disclosure provide systems and methods for automatically selecting one or more flight strategies for aircraft that are scheduled to arrive at an airport.

While various spatial and directional terms, such as top, bottom, lower, mid, lateral, horizontal, vertical, front and the like may be used to describe examples of the subject disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) may be used in combination with each other. In addition, many modifications may be made to adapt a particular situation or material to the teachings of the various examples of the disclosure without departing from their scope. While the dimensions and types of materials described herein are intended to define the parameters of the various examples of the disclosure, the examples are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

Further, the disclosure comprises examples according to the following clauses:

Clause 1. An aircraft flight strategy selection system that is configured to identify one or more possible flight strategies for an aircraft at an airport, the aircraft flight strategy selection system comprising:

a flight strategy analysis control unit that determines the one or more possible flight strategies for the aircraft based on weather forecast data for a selected time period, flight schedule data for the selected time period, historical weather data for a prior time frame, and historical flight schedule data for the prior time frame.

Clause 2. The aircraft flight strategy selection system of clause 1, further comprising a historical flight strategy database in communication with the flight strategy analysis control unit, wherein the historical flight strategy database stores historical flight strategy data regarding various flight strategies to the airport during the prior time frame.

Clause 3. The aircraft flight strategy selection system of clause 2, wherein the flight strategy analysis control unit analyzes the historical flight strategy data for a prior time period that is similar to the selected time period and identifies one or more flight strategies for the prior time period as the one or more possible flight strategies for the selected time period.

Clause 4. The aircraft flight strategy selection system of clause 3, wherein the flight strategy analysis control unit comprises a strategies selection module that analyzes the historical flight strategy data and identifies the one or more possible flight strategies for the selected time period.

Clause 5. The aircraft flight strategy selection system of any one of clauses 1-4, further comprising a historical weather database in communication with the flight strategy analysis control unit, wherein the historical weather database stores the historical weather data, wherein the flight strategy analysis control unit compares the weather forecast data for the selected time period with the historical weather data, and wherein the flight strategy analysis control unit determines one or more time periods from the historical weather data having weather conditions that are at least substantially similar as weather conditions for the selected time period as determined via the weather forecast data.

Clause 6. The aircraft flight strategy selection system of clause 5, wherein the flight strategy analysis control unit comprises a conditions comparison module that analyzes the historical weather data and the weather forecast data.

Clause 7. The aircraft flight strategy selection system of any one of clauses 1-6, further comprising a weather forecasting sub-system in communication with the flight strategy analysis control unit, wherein the flight strategy analysis control unit receives the weather forecast data from the weather forecasting sub-system.

Clause 8. The aircraft flight strategy selection system of any one of clauses 1-7, further comprising a historical flight schedule database in communication with the flight strategy analysis control unit, wherein the historical flight schedule database stores the historical flight schedule data, wherein the flight strategy analysis control unit compares the flight schedule data with the historical flight schedule data, and wherein the flight strategy analysis control unit determines one or more days from the historical flight schedule data having a prior flight schedule that is at least substantially similar as a future flight schedule as determined via the flight schedule data for the selected time period.

Clause 9. The aircraft flight strategy selection system of clause 8, wherein the flight strategy analysis control unit comprises a conditions comparison module that analyzes the historical flight schedule data and the flight schedule data.

Clause 10. The aircraft flight strategy selection system of clause 1, further comprising a flight schedule sub-system in communication with the flight strategy analysis control unit, wherein the flight strategy analysis control unit receives the flight schedule data from the flight schedule sub-system.

Clause 11. The aircraft flight strategy selection system of any one of clauses 1-10, further comprising an aircraft database in communication with the flight strategy analysis control unit, wherein the aircraft database stores aircraft data regarding the aircraft, and wherein the flight strategy analysis control unit analyzes the aircraft data to determine capabilities of the aircraft and aircraft capable flight strategies for the aircraft.

Clause 12. The aircraft flight strategy selection system of clause 11, wherein the flight strategy analysis control unit comprises an aircraft capabilities module that analyzes the aircraft data.

Clause 13. The aircraft flight strategy selection system of any one of clauses 1-12, wherein the flight strategy analysis control unit compares the one or more possible flight strategies for the selected time period in relation to one or more metrics including one or more of flight time, fuel consumption, or generated noise.

Clause 14. The aircraft flight strategy selection system of clause 13, wherein the flight strategy analysis control unit comprises a strategies comparison module that associates the one or more metrics with the one or more possible flight strategies for the selected time period.

Clause 15. An aircraft flight strategy determination method that is configured to determine one or more possible flight strategies for an aircraft at an airport, the aircraft flight strategy determination method comprising:

determining, by a flight strategy analysis control unit, the one or more possible flight strategies for the aircraft based on weather forecast data for a selected time period, flight schedule data for the selected time period, historical weather data for a prior time frame, and historical flight schedule data for the prior time frame.

Clause 16. The aircraft flight strategy determination method of clause 15, further comprising:

storing, in a historical flight strategy database that is in communication with the flight strategy analysis control unit, historical flight strategy data regarding various flight strategies to the airport during the prior time frame;

analyzing, by the flight strategy analysis control unit, the historical flight strategy data for a prior time period that is similar to the selected time period; and

identifying, by the flight strategy analysis control unit, one or more flight strategies for the prior time period as the one or more possible flight strategies for the selected time period.

Clause 17. The aircraft flight strategy determination method of any one of clauses 15-16, further comprising:

storing, in a historical weather database that is in communication with the flight strategy analysis control unit, the historical weather data;

comparing, by the flight strategy analysis control unit, the weather forecast data for the selected time period with the historical weather data; and

determining, by the flight strategy analysis control unit, one or more time periods from the historical weather data having weather conditions that are at least substantially similar as weather conditions for the selected time period as determined via the weather forecast data.

Clause 18. The aircraft flight strategy determination method of any one of clauses 15-17, further comprising receiving the weather forecast data from a weather forecasting sub-system that is in communication with the flight strategy analysis control unit.

Clause 19. The aircraft flight strategy determination method of any one of clauses 15-18, further comprising:

storing, in a historical flight schedule database that is in communication with the flight strategy analysis control unit, the historical flight schedule data;

comparing, by the flight strategy analysis control unit, the flight schedule data with the historical flight schedule data; and

determining, by the flight strategy analysis control unit, one or more days from the historical flight schedule data having a prior flight schedule that is at least substantially similar as a future flight schedule as determined via the flight schedule data for the selected time period.

Clause 20. The aircraft flight strategy determination method of any one of clauses 15-19, further comprising receiving, from a flight schedule sub-system that is in communication with the flight strategy analysis control unit, the flight schedule data.

Clause 21. The aircraft flight strategy determination method of any one of clauses 15-20, further comprising:

storing, in an aircraft database that is in communication with the flight strategy analysis control unit, aircraft data regarding the aircraft; and

analyzing, by the flight strategy analysis control unit, the aircraft data to determine capabilities of the aircraft and aircraft capable flight strategies for the aircraft.

Clause 22. The aircraft flight strategy determination method of any one of clauses 15-21, further comprising:

comparing, by the flight strategy analysis control unit, the one or more possible flight strategies for the selected time period in relation to one or more metrics including one or more of flight time, fuel consumption, or generated noise.

Clause 23. An aircraft flight strategy selection system that is configured to determine one or more possible flight strategies for an aircraft at an airport, the aircraft flight strategy selection system comprising:

a flight strategy analysis control unit that determines the one or more possible flight strategies for the aircraft based on weather forecast data for a selected time period, flight schedule data for the selected time period, historical weather data for a prior time frame, and historical flight schedule data for the prior time frame;

an aircraft database in communication with the flight strategy analysis control unit, wherein the aircraft database stores aircraft data regarding the aircraft, and wherein the flight strategy analysis control unit analyzes the aircraft data to determine capabilities of the aircraft and aircraft capable flight strategies for the aircraft;

a historical weather database in communication with the flight strategy analysis control unit, wherein the historical weather database stores the historical weather data, wherein the flight strategy analysis control unit compares the weather forecast data for the selected time period with the historical weather data, and wherein the flight strategy analysis control unit determines one or more time periods from the historical weather data having weather conditions that are at least substantially similar as weather conditions for the selected time period as determined via the weather forecast data;

a weather forecasting sub-system in communication with the flight strategy analysis control unit, wherein the flight strategy analysis control unit receives the weather forecast data from the weather forecasting sub-system;

a historical flight schedule database in communication with the flight strategy analysis control unit, wherein the historical flight schedule database stores the historical flight schedule data, wherein the flight strategy analysis control unit compares the flight schedule data with the historical flight schedule data, and wherein the flight strategy analysis control unit determines the one or more time periods from the historical flight schedule data having a prior flight schedule that is at least substantially similar as a future flight schedule as determined via the flight schedule data for the selected time period;

a flight schedule sub-system in communication with the flight strategy analysis control unit, wherein the flight strategy analysis control unit receives the flight schedule data from the flight schedule sub-system; and a historical flight strategy database in communication with the flight strategy analysis control unit, wherein the historical flight strategy database stores historical flight strategy data regarding various flight strategies to the airport during the prior time frame, wherein the flight strategy analysis control unit analyzes the historical flight strategy data for a prior time period that is similar to the selected time period and identifies one or more flight strategies for the prior time period as the one or more possible flight strategies for the selected time period.

Clause 24. The aircraft flight strategy selection system of clause 23, wherein the flight strategy analysis control unit compares the one or more possible flight strategies for the selected time period in relation to one or more metrics including one or more of flight time, fuel consumption, or generated noise.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

1. An aircraft flight strategy selection system, comprising:
a flight strategy analysis control unit that determines one or more possible flight strategies for an aircraft at an airport based on weather forecast data for a selected time period, flight schedule data for the selected time period, historical weather data for a prior time frame, and historical flight schedule data for the prior time frame.

2. The aircraft flight strategy selection system of claim 1, further comprising a historical flight strategy database in communication with the flight strategy analysis control unit, wherein the historical flight strategy database stores historical flight strategy data regarding various flight strategies to the airport during the prior time frame.

3. The aircraft flight strategy selection system of claim 2, wherein the flight strategy analysis control unit analyzes the historical flight strategy data for a prior time period that is similar to the selected time period and identifies one or more flight strategies for the prior time period as the one or more possible flight strategies for the selected time period.

4. The aircraft flight strategy selection system of claim 3, wherein the flight strategy analysis control unit comprises a strategies selection module that analyzes the historical flight strategy data and identifies the one or more possible flight strategies for the selected time period.

5. The aircraft flight strategy selection system of claim 1, further comprising a historical weather database in communication with the flight strategy analysis control unit, wherein the historical weather database stores the historical weather data, wherein the flight strategy analysis control unit compares the weather forecast data for the selected time period with the historical weather data, and wherein the flight strategy analysis control unit determines one or more time periods from the historical weather data having weather conditions that are at least substantially similar as weather conditions for the selected time period as determined via the weather forecast data.

6. The aircraft flight strategy selection system of claim 5, wherein the flight strategy analysis control unit comprises a conditions comparison module that analyzes the historical weather data and the weather forecast data.

7. The aircraft flight strategy selection system of claim 1, further comprising a weather forecasting sub-system in communication with the flight strategy analysis control unit, wherein the flight strategy analysis control unit receives the weather forecast data from the weather forecasting sub-system.

8. The aircraft flight strategy selection system of claim 1, further comprising a historical flight schedule database in communication with the flight strategy analysis control unit, wherein the historical flight schedule database stores the historical flight schedule data, wherein the flight strategy analysis control unit compares the flight schedule data with the historical flight schedule data, and wherein the flight strategy analysis control unit determines one or more days from the historical flight schedule data having a prior flight schedule that is at least substantially similar as a future flight schedule as determined via the flight schedule data for the selected time period.

9. The aircraft flight strategy selection system of claim 8, wherein the flight strategy analysis control unit comprises a conditions comparison module that analyzes the historical flight schedule data and the flight schedule data.

10. The aircraft flight strategy selection system of claim 1, further comprising a flight schedule sub-system in communication with the flight strategy analysis control unit, wherein the flight strategy analysis control unit receives the flight schedule data from the flight schedule sub-system.

11. The aircraft flight strategy selection system of claim 1, further comprising an aircraft database in communication with the flight strategy analysis control unit, wherein the aircraft database stores aircraft data regarding the aircraft, and wherein the flight strategy analysis control unit analyzes the aircraft data to determine capabilities of the aircraft and aircraft capable flight strategies for the aircraft.

12. The aircraft flight strategy selection system of claim 11, wherein the flight strategy analysis control unit comprises an aircraft capabilities module that analyzes the aircraft data.

13. The aircraft flight strategy selection system of claim 1, wherein the flight strategy analysis control unit compares the one or more possible flight strategies for the selected time period in relation to one or more metrics including one or more of flight time, fuel consumption, or generated noise.

14. The aircraft flight strategy selection system of claim 13, wherein the flight strategy analysis control unit comprises a strategies comparison module that associates the one or more metrics with the one or more possible flight strategies for the selected time period.

15. An aircraft flight strategy determination method, comprising:
determining, by a flight strategy analysis control unit, one or more possible flight strategies for an aircraft at an airport based on weather forecast data for a selected time period, flight schedule data for the selected time period, historical weather data for a prior time frame, and historical flight schedule data for the prior time frame.

16. The aircraft flight strategy determination method of claim 15, further comprising:
storing, in a historical flight strategy database that is in communication with the flight strategy analysis control unit, historical flight strategy data regarding various flight strategies to the airport during the prior time frame;
analyzing, by the flight strategy analysis control unit, the historical flight strategy data for a prior time period that is similar to the selected time period; and
identifying, by the flight strategy analysis control unit, one or more flight strategies for the prior time period as the one or more possible flight strategies for the selected time period.

17. The aircraft flight strategy determination method of claim 15, further comprising:
storing, in a historical weather database that is in communication with the flight strategy analysis control unit, the historical weather data;
comparing, by the flight strategy analysis control unit, the weather forecast data for the selected time period with the historical weather data; and
determining, by the flight strategy analysis control unit, one or more time periods from the historical weather data having weather conditions that are at least substantially similar as weather conditions for the selected time period as determined via the weather forecast data.

18. The aircraft flight strategy determination method of claim 15, further comprising receiving at least one of the weather forecast data from a weather forecasting sub-system that is in communication with the flight strategy analysis control unit or the flight schedule data from a flight schedule sub-system that is in communication with the flight strategy analysis control unit.

19. An aircraft flight strategy selection system, comprising:
a flight strategy analysis control unit that determines one or more possible flight strategies for an aircraft based on weather forecast data for a selected time period, flight schedule data for the selected time period, historical weather data for a prior time frame, and historical flight schedule data for the prior time frame;
an aircraft database in communication with the flight strategy analysis control unit, wherein the aircraft database stores aircraft data regarding the aircraft, and wherein the flight strategy analysis control unit analyzes the aircraft data to determine capabilities of the aircraft and aircraft capable flight strategies for the aircraft;
a historical weather database in communication with the flight strategy analysis control unit, wherein the historical weather database stores the historical weather data, wherein the flight strategy analysis control unit compares the weather forecast data for the selected time period with the historical weather data, and wherein the flight strategy analysis control unit determines one or more time periods from the historical weather data having weather conditions that are at least substantially similar as weather conditions for the selected time period as determined via the weather forecast data;
a weather forecasting sub-system in communication with the flight strategy analysis control unit, wherein the flight strategy analysis control unit receives the weather forecast data from the weather forecasting sub-system;
a historical flight schedule database in communication with the flight strategy analysis control unit, wherein the historical flight schedule database stores the historical flight schedule data, wherein the flight strategy analysis control unit compares the flight schedule data with the historical flight schedule data, and wherein the flight strategy analysis control unit determines the one or more time periods from the historical flight schedule data having a prior flight schedule that is at least substantially similar as a future flight schedule as determined via the flight schedule data for the selected time period;
a flight schedule sub-system in communication with the flight strategy analysis control unit, wherein the flight strategy analysis control unit receives the flight schedule data from the flight schedule sub-system; and
a historical flight strategy database in communication with the flight strategy analysis control unit, wherein the historical flight strategy database stores historical flight strategy data regarding various flight strategies to an airport during the prior time frame, wherein the flight strategy analysis control unit analyzes the historical flight strategy data for a prior time period that is similar to the selected time period and identifies one or more flight strategies for the prior time period as the one or more possible flight strategies for the selected time period.

20. The aircraft flight strategy selection system of claim 19, wherein the flight strategy analysis control unit compares the one or more possible flight strategies for the selected time period in relation to one or more metrics including one or more of flight time, fuel consumption, or generated noise.
